(19) United States
(12) Patent Application Publication
(10) Pub. No.: US 2024/0346682 A1
(43) Pub. Date: Oct. 17, 2024

(54) SLAM METHOD AND DEVICE BASED ON SPARSE DEPTH IMAGE, TERMINAL EQUIPMENT AND MEDIUM

(71) Applicant: RUICHI ZHIHUI TECHNOLOGY (AN JI) CO., LTD, Huzhou (CN)

(72) Inventor: Long TANG, Huzhou (CN)

(73) Assignee: RUICHI ZHIHUI TECHNOLOGY (AN JI) CO., LTD, Huzhou (CN)

(21) Appl. No.: 18/500,555

(22) Filed: Nov. 2, 2023

(30) Foreign Application Priority Data
Apr. 11, 2023 (CN) 202310379777.2

(51) Int. Cl. G06T 7/70

(52) U.S. Cl. CPC G06T 7/70; G06T 2207/10028; G06T 2207/30241

(57) ABSTRACT

Disclosed are a simultaneous localization and mapping (SLAM) method and a device based on a sparse depth image, a terminal equipment and a medium. The SLAM method based on a sparse depth image includes: acquiring an environment image collected by a camera and an environment sparse depth image collected by a time of flight (TOF) sensor, and analyzing and processing the environment image and the environment sparse depth image through a preset SLAM system to acquire corresponding pose information. The pose information is used for localization, mapping and path planning of an unmanned system.

### CROSS-REFERENCE TO RELATED APPLICATIONS

This application claims priority to Chinese Patent Application No. 202310379777.2, filed on Apr. 11, 2023, the entire contents of which are incorporated herein by reference.

### TECHNICAL FIELD

The present application relates to the technical field of machine vision, and in particular to a simultaneous localization and mapping (SLAM) method and a device based on a sparse depth image, a terminal equipment and a medium.

### BACKGROUND

SLAM technology, also known as simultaneous localization and mapping technology, is usually used for localization, mapping, and path planning of the unmanned system, and the depth information should be inputted to the SLAM system during the implementation process. For example, in RGB-D SLAM, high-resolution depth images are inputted to the SLAM system, but generating high-resolution depth images in the early stages requires a long time. For another example, the laser SLAM acquires point cloud data through the laser radar, and the point cloud data is actually a kind of coordinate data. A series of calculations should be performed to convert the point cloud data into a point cloud image with distance (depth) information. The point cloud image with distance (depth) information is inputted to the SLAM system, and the calculation process also takes a long time.

In summary, the conventional SLAM technology takes a long time to prepare depth information which is inputted to the SLAM system, leading to the slow operation speed of the SLAM system.

### SUMMARY

The main purpose of the present application is to provide a simultaneous localization and mapping (SLAM) method and a device based on a sparse depth image, a terminal equipment and a medium, aiming to solve the technical problem of the slow operating speed of the SLAM system.

In order to solve the above objectives, the present application provides an SLAM method based on a sparse depth image, including:

acquiring an environment image collected by a camera and an environment sparse depth image collected by a time of flight (TOF) sensor; and

analyzing and processing the environment image and the environment sparse depth image through a preset SLAM system to acquire corresponding pose information, the pose information being used for localization, mapping and path planning of an unmanned system.

In an embodiment, before the analyzing and processing the environment image and the environment sparse depth image through the preset SLAM system to acquire the corresponding pose information, the SLAM method further includes:

acquiring inertial information of the unmanned system collected by an inertial sensor; and

the analyzing and processing the environment image and the environment sparse depth image through the preset SLAM system to acquire the corresponding pose information includes:

analyzing and processing the environment image, the environment sparse depth image, and the inertial information of the unmanned system through the preset SLAM system to acquire the corresponding pose information.

In an embodiment, the preset SLAM system includes a system hub module, a trajectory tracking module and an image frame module, and the analyzing and processing the environment image, the environment sparse depth image, and the inertial information of the unmanned system through the preset SLAM system to acquire the corresponding pose information includes:

analyzing and processing the environment image, the environment sparse depth image, and the inertial information of the unmanned system through the system hub module, the trajectory tracking module, and the image frame module of the preset SLAM system respectively, to acquire the corresponding pose information.

In an embodiment, the preset SLAM system further includes a dense depth information output module, and the analyzing and processing the environment image, the environment sparse depth image, and the inertial information of the unmanned system through the system hub module, the trajectory tracking module, and the image frame module of the preset SLAM system respectively, to acquire the corresponding pose information includes:

analyzing and processing the environment image, the environment sparse depth image, and the inertial information of the unmanned system through the system hub module, the trajectory tracking module, the image frame module, and the dense depth information output module of the preset SLAM system respectively, to acquire pose information with dense depth information.

In an embodiment, after the analyzing and processing the environment image, the environment sparse depth image, and the inertial information of the unmanned system through the system hub module, the trajectory tracking module, the image frame module, and the dense depth information output module of the preset SLAM system respectively, to acquire the pose information with the dense depth information, the SLAM method further includes:

planning and acquiring an obstacle avoidance path of the unmanned system according to the pose information with the dense depth information.

In an embodiment, the analyzing and processing the environment image and the environment sparse depth image through the preset SLAM system to acquire the corresponding pose information includes:

analyzing and processing the environment image, the environment sparse depth image, and the inertial information of the unmanned system through a preset vision-based SLAM system to acquire the corresponding pose information.

In an embodiment, the analyzing and processing the environment image, the environment sparse depth image, and the inertial information of the unmanned system through the preset vision-based SLAM system to acquire the corresponding pose information includes:

analyzing and processing the environment image, the environment sparse depth image, and the inertial information of the unmanned system through a preset Oriented FAST and Rotated BRIEF (ORB) SLAM system to acquire the corresponding pose information.

Embodiments of the present application further provide an SLAM device based on a sparse depth image, including:

an acquisition module configured to acquire an environment image collected by a camera and an environment sparse depth image collected by a TOF sensor; and

an analysis module configured to analyze and process the environment image and the environment sparse depth image through a preset SLAM system to acquire corresponding pose information, the pose information being used for localization, mapping and path planning of an unmanned system.

Embodiments of the present application further provide a terminal equipment, including a memory, a processor, and an SLAM program based on a sparse depth image stored in the memory and executable on the processor. When the SLAM program based on the sparse depth image is executed by the processor, the SLAM method based on the sparse depth image as mentioned above is implemented.

Embodiments of the present application further provide a non-transitory computer-readable storage medium. An SLAM program based on a sparse depth image is stored in the non-transitory computer-readable storage medium, and when the SLAM program based on the sparse depth image is executed by a processor, the SLAM method based on the sparse depth image as mentioned above is implemented.

The present application provides an SLAM method and a device based on a sparse depth image, a terminal equipment and a medium. By acquiring an environment image collected by a camera and an environment sparse depth image collected by the TOF sensor, and analyzing and processing the environment image and the environment sparse depth image through a preset SLAM system, the corresponding pose information can be acquired. The pose information is used for localization, mapping and path planning of an unmanned system. In this embodiment, the environment sparse depth image collected by the TOF sensor is used to provide the necessary depth information for the SLAM system, and combined with the environment image collected by the camera inputted to the SLAM system, the SLAM system can further analyze and acquire the corresponding pose information. In this way, by inputting the environment sparse depth image, the time for preparing depth information can be effectively reduced, and the operating speed of the SLAM system can be improved. Further, the performance of the SLAM system can be enhanced and energy consumption can be reduced.

### BRIEF DESCRIPTION OF THE DRAWINGS

FIG. 1 is a schematic diagram of functional modules in a terminal equipment to which the simultaneous localization and mapping (SLAM) device based on a sparse depth image of the present application belongs.

FIG. 2 is a schematic flowchart of the SLAM method based on the sparse depth image according to a first embodiment of the present application.

FIG. 3 is a schematic diagram of the sparse depth image related to the SLAM method based on the sparse depth image of the present application.

FIG. 4 is a first system architecture diagram related to the SLAM method based on the sparse depth image of the present application.

FIG. 5 is a schematic flowchart of the SLAM method based on the sparse depth image according to a second embodiment of the present application.

FIG. 6 is a second system architecture diagram related to the SLAM method based on the sparse depth image of the present application.

FIG. 7 is a schematic flowchart of the SLAM method based on the sparse depth image according to a third embodiment of the present application.

FIG. 8 is a third system architecture diagram related to the SLAM method based on the sparse depth image of the present application.

FIG. 9 is a schematic flowchart of the SLAM method based on the sparse depth image according to a fourth embodiment of the present application.

FIG. 10 is a fourth system architecture diagram related to the SLAM method based on the sparse depth image of the present application.

FIG. 11 is a schematic flowchart of the SLAM method based on the sparse depth image according to a fifth embodiment of the present application.

FIG. 12 is a schematic flowchart of the SLAM method based on the sparse depth image according to a sixth embodiment of the present application.

FIG. 13 is a schematic flowchart of the SLAM method based on the sparse depth image according to a seventh embodiment of the present application.

The realization of the objective, functional characteristics, and advantages of the present application are further described with reference to the accompanying drawings.

### DETAILED DESCRIPTION OF THE EMBODIMENTS

It should be understood that the specific embodiments described here are only used to explain the present application, and are not intended to limit the present application.

The main solution of the embodiment of the present application is: acquiring an environment image collected by a camera and an environment sparse depth image collected by a time of flight (TOF) sensor, and analyzing and processing the environment image and the environment sparse depth image through a preset SLAM system to acquire corresponding pose information, and the pose information is used for localization, mapping and path planning of an unmanned system. Based on the technical solution of the present application, the environment sparse depth image collected by the TOF sensor is used to provide the necessary depth information for the SLAM system, and combined with the environment image collected by the camera inputted to the SLAM system, the SLAM system can further analyze and acquire the corresponding pose information. In this way, by inputting the environment sparse depth image, the time for preparing depth information can be effectively reduced, and the operating speed of the SLAM system can be improved.

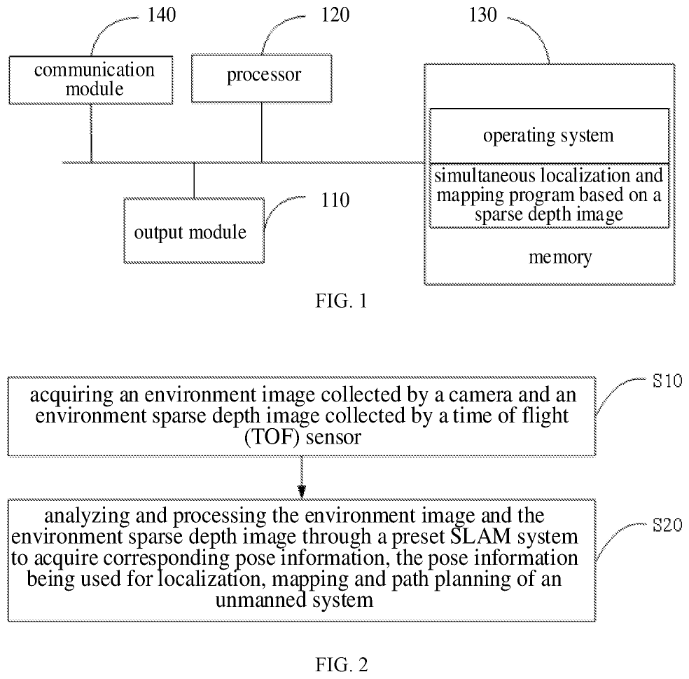

As shown in FIG. 1, which is a schematic diagram of functional modules in a terminal equipment to which the SLAM device based on a sparse depth image of the present application belongs. The SLAM device based on the sparse depth image may be a device capable of performing SLAM based on sparse depth images and independent of the terminal equipment, and the SLAM device may be carried on the terminal equipment in the form of hardware or software. The terminal equipment may be an intelligent mobile terminal with the data processing function such as a mobile phone or a tablet computer, or may be a fixed terminal equipment or a server with the data processing function.

In this embodiment, the terminal equipment to which the SLAM device based on the sparse depth image belongs includes at least an output module 110, a processor 120, a memory 130 and a communication module 140.

An operating system and an SLAM program based on the sparse depth image are stored in the memory 130. The acquired environment image collected by a camera, and the environment sparse depth image collected by a TOF sensor can be stored in the memory 130 by the SLAM device based on the sparse depth image. Further, after the environment image and the environment sparse depth image are analyzed and processed by the preset SLAM system, the acquired corresponding pose information and other information can be stored in the memory 130 by the SLAM device based on the sparse depth image. The output module 110 can be a display screen or the like. The communication module 140 may include a WIFI module, a mobile communication module, a Bluetooth module, and the like, and communication between the communication module 140 with external devices or servers can be achieved.

When the SLAM program based on the sparse depth image in the memory 130 is executed by the processor, the following operations are implemented:

acquiring an environment image collected by a camera and an environment sparse depth image collected by a TOF sensor; and

analyzing and processing the environment image and the environment sparse depth image through a preset SLAM system to acquire corresponding pose information, the pose information being used for localization, mapping and path planning of an unmanned system.

Further, when the SLAM program based on the sparse depth image in the memory 130 is executed by the processor, the following operations are implemented:

acquiring inertial information of the unmanned system collected by an inertial sensor; and

analyzing and processing the environment image, the environment sparse depth image, and the inertial information of the unmanned system through the preset SLAM system to acquire the corresponding pose information.

Further, when the SLAM program based on the sparse depth image in the memory 130 is executed by the processor, the following operations are implemented:

analyzing and processing the environment image, the environment sparse depth image, and the inertial information of the unmanned system through the system hub module, the trajectory tracking module, and the image frame module of the preset SLAM system respectively, to acquire the corresponding pose information.

Further, when the SLAM program based on the sparse depth image in the memory 130 is executed by the processor, the following operations are implemented:

analyzing and processing the environment image, the environment sparse depth image, and the inertial information of the unmanned system through the system hub module, the trajectory tracking module, the image frame module, and the dense depth information output module of the preset SLAM system respectively, to acquire pose information with dense depth information.

Further, when the SLAM program based on the sparse depth image in the memory 130 is executed by the processor, the following operations are implemented:

planning and acquiring an obstacle avoidance path of the unmanned system according to the pose information with the dense depth information.

Further, when the SLAM program based on the sparse depth image in the memory 130 is executed by the processor, the following operations are implemented:

analyzing and processing the environment image, the environment sparse depth image, and the inertial information of the unmanned system through a preset vision-based SLAM system to acquire the corresponding pose information.

Further, when the SLAM program based on the sparse depth image in the memory 130 is executed by the processor, the following operations are implemented:

analyzing and processing the environment image, the environment sparse depth image, and the inertial information of the unmanned system through a preset Oriented FAST and Rotated BRIEF (ORB) SLAM system to acquire the corresponding pose information.

In an embodiment, by the above-mentioned solution, specifically, by acquiring an environment image collected by a camera and an environment sparse depth image collected by the TOF sensor, and analyzing and processing the environment image and the environment sparse depth image through a preset SLAM system, the corresponding pose information can be acquired. The pose information is used for localization, mapping and path planning of an unmanned system. In this embodiment, the environment sparse depth image collected by the TOF sensor is used to provide the necessary depth information for the SLAM system, and combined with the environment image collected by the camera inputted to the SLAM system, the SLAM system can further analyze and acquire the corresponding pose information. In this way, by inputting the environment sparse depth image, the time for preparing depth information can be effectively reduced, and the operating speed of the SLAM system can be improved. Further, the performance of the SLAM system can be enhanced and energy consumption can be reduced.

As shown in FIG. 2, the first embodiment of the SLAM method based on sparse depth images of the present application provides a schematic flowchart, and the SLAM method based on the sparse depth image includes following operations.

Operation S10, acquiring an environment image collected by a camera and an environment sparse depth image collected by a TOF sensor.

To realize the localization, mapping and path planning of the unmanned system, it is necessary to input the depth information to the SLAM system. There are mainly two conventional methods for providing depth information to SLAM systems.

The first method is to generate a high-resolution depth image inputted to the SLAM system on the RGB-D SLAM architecture. The high-resolution depth image includes more pixels, and can reflect very detailed environmental information. However, some information in the high-resolution depth image is redundant information, which is not helpful for the localization, mapping and path planning of unmanned systems. Moreover, the process of generating high-resolution depth images takes a long time, which reduces the operating speed of the SLAM system.

The second method is in the laser SLAM architecture, the point cloud data undergoes a series of computations to generate a point cloud image with distance (depth) information. The information amount of the point cloud image is relatively less than that of the high-resolution depth image, and can provide the necessary depth information for SLAM systems. However, the process of converting point cloud data into point cloud images takes a lot of computations and a long time, reducing the operating speed of the SLAM system.

In view of this, the present application provides an SLAM method based on the sparse depth image, which can be applied to unmanned systems, such as lawn mowing robots, sweeping robots, or mobile terminals such as smart phones, tablet computers, and VR glasses. The sparse depth image is an image different from the high-resolution depth image and the point cloud image mentioned above. The sparse depth image includes sparse depth information, as shown in FIG. 3, which is a schematic diagram of the sparse depth image related to the SLAM method based on the sparse depth image of the present application. Black dots represent pixels with depth information. The term “sparse” means that the pixels with depth information only occupy a small part of the overall image pixels, and are sparsely distributed. The environment sparse depth image refers to the sparse depth image collected based on the surrounding environment of the unmanned system.

Taking a lawn mowing robot as an example to illustrate the acquisition process of the environment image and the environment sparse depth image. In terms of hardware, the camera and the TOF sensor need to be supported in the lawn mowing robot. TOF is the abbreviation of time of flight. The TOF sensor will perform localization and communication on the object by measuring the time for light to reflect from the object. That is to say, the environment sparse depth image collected by the TOF sensor includes the distance (depth) information.

Moreover, the lawn mowing robot is provided with a monocular camera or a binocular camera, and the camera can capture images of the surrounding environment of the lawn mowing robot. The lawn mowing robot is provided with a TOF sensor, and the TOF sensor can collect the sparse depth image of the environment around the lawn mowing robot.

Operation S20, analyzing and processing the environment image and the environment sparse depth image through a preset SLAM system to acquire corresponding pose information, the pose information being used for localization, mapping and path planning of an unmanned system.

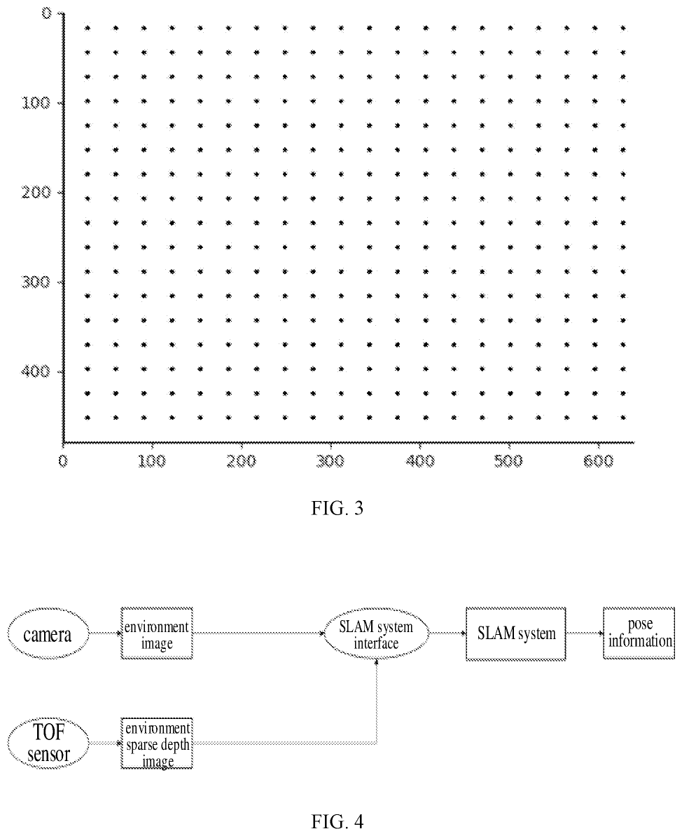

As shown in FIG. 4, which is a first system architecture diagram related to the SLAM method based on the sparse depth image of the present application. After the environment image collected by the camera and the environment sparse depth image collected by the TOF sensor are acquired, the environment image and the environment sparse depth image are transmitted to the SLAM system interface, then transmitted to the SLAM system via the SLAM system interface. That is, the environment image and the environment sparse depth image will be inputted to the SLAM system. Furthermore, the SLAM system performs will analyze and process the environment image and the environment sparse depth image, and finally will output the corresponding pose information. The pose information includes the current location and the speed of the unmanned system and other information used for localization, mapping and path planning.

In this embodiment, by the above-mentioned solution, specifically, by acquiring an environment image collected by a camera and an environment sparse depth image collected by the TOF sensor, and analyzing and processing the environment image and the environment sparse depth image through a preset SLAM system, the corresponding pose information can be acquired. The pose information is used for localization, mapping and path planning of an unmanned system. In this embodiment, the environment sparse depth image collected by the TOF sensor is used to provide the necessary depth information for the SLAM system, and combined with the environment image collected by the camera inputted to the SLAM system, the SLAM system can further analyze and acquire the corresponding pose information. In this way, by inputting the environment sparse depth image, the time for preparing depth information can be effectively reduced, and the operating speed of the SLAM system can be improved. Further, the performance of the SLAM system can be enhanced and energy consumption can be reduced.

Further, as shown in FIG. 5, the second embodiment of the SLAM method based on sparse depth images of the present application provides a schematic flowchart. Based on the above embodiments, before operation S20, analyzing and processing the environment image and the environment sparse depth image through the preset SLAM system to acquire the corresponding pose information, the SLAM method based on the sparse depth image further includes following operations.

Operation S001, acquiring inertial information of the unmanned system collected by an inertial sensor.

The vision-based SLAM system is easily affected by image occlusion, light change, moving object interference, weak texture scene and the like. In view of this, this embodiment provides the inertial information inputted to the SLAM system. Moreover, an inertial sensor (or IMU sensor) is preset in the unmanned system. Through the inertial sensor, the inertial information of the unmanned system can be collected. The inertial information includes acceleration, tilt, impact, vibration, rotation, and one or more of the multiple degrees of freedom (DOF) motions.

Operation S20, the analyzing and processing the environment image and the environment sparse depth image through the preset SLAM system to acquire the corresponding pose information includes:

operation S201, analyzing and processing the environment image, the environment sparse depth image, and the inertial information of the unmanned system through the preset SLAM system to acquire the corresponding pose information.

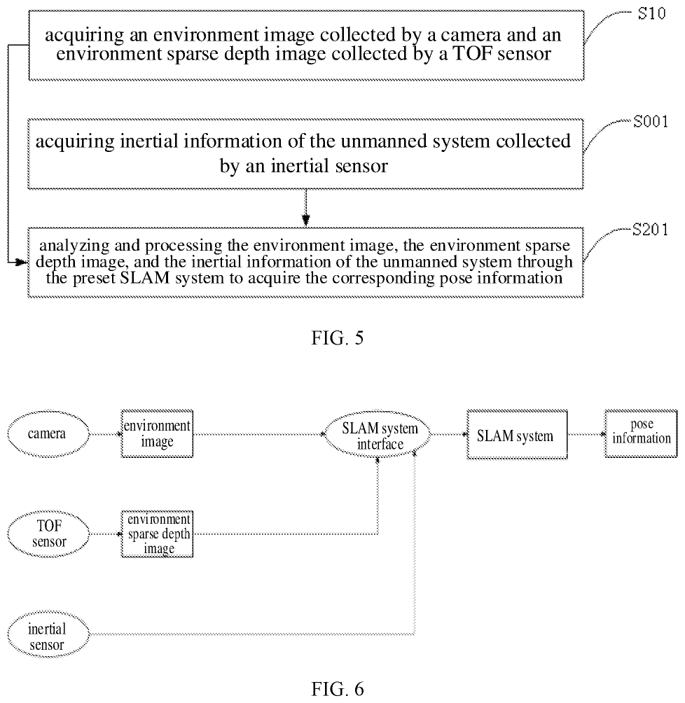

As shown in FIG. 6, which is a second system architecture diagram related to the SLAM method based on the sparse depth image of the present application. After the environment image, the environment sparse depth image, and the inertial information are acquired, the environment image, the environment sparse depth image, and the inertial information are transmitted to the SLAM system interface, then transmitted to the SLAM system via the SLAM system interface. That is, the environment image, the environment sparse depth image, the inertial information are inputted to the SLAM system. Furthermore, the SLAM system will analyze and process the environment image, the environment sparse depth image, and the inertial information, and finally will output the corresponding pose information. The pose information includes the current location and the speed of the unmanned system and other information used for localization, mapping and path planning.

After combining the vision-based SLAM with the inertial sensor, the respective disadvantages of the vision-based SLAM and the inertial sensor will be compensated. The visual localization information can be used to estimate the zero bias of the inertial sensor, reducing the divergence and cumulative errors caused by the zero bias of the inertial sensor. The inertial sensor can provide the vision-based SLAM with the localization and scale information during the fast movement, to avoid that the vision-based SLAM cannot measure the scale.

In this embodiment, by the above-mentioned solution, specifically, by acquiring inertial information of the unmanned system collected by an inertial sensor, and analyzing and processing the environment image, the environment sparse depth image, and the inertial information of the unmanned system through the preset SLAM system, the corresponding pose information can be acquired. In this way, by inputting the inertial information, it can be ensured that the inertial information can effectively compensate the disadvantages of the SLAM system, thereby improving the accuracy of localization, mapping and routing of unmanned systems.

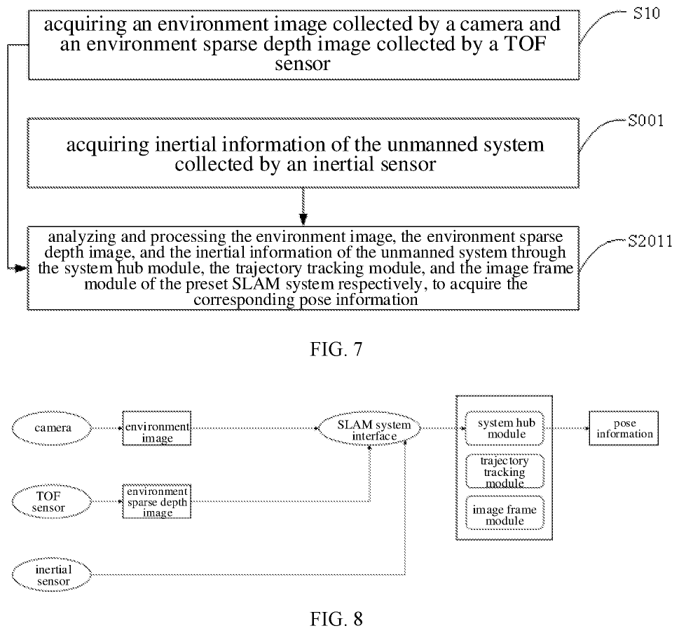

Further, as shown in FIG. 7, the third embodiment of the SLAM method based on sparse depth images of the present application provides a schematic flowchart. Based on the above embodiments shown in FIG. 5, the preset SLAM system includes a system hub module, a trajectory tracking module and an image frame module. Operation S201, analyzing and processing the environment image, the environment sparse depth image, and the inertial information of the unmanned system through the preset SLAM system to acquire the corresponding pose information includes:

operation S2011, analyzing and processing the environment image, the environment sparse depth image, and the inertial information of the unmanned system through the system hub module, the trajectory tracking module, and the image frame module of the preset SLAM system respectively, to acquire the corresponding pose information.

As shown in FIG. 8, which is a third system architecture diagram related to the SLAM method based on the sparse depth image of the present application. The SLAM system in this embodiment may include three modules, namely a system hub module, a trajectory tracking module and an image frame module. The system hub module is configured to perform the main calculation tasks. The trajectory tracking module is configured to calculate and track the trajectory of the unmanned system. The image frame module is configured to control the output rate, thereby affecting real-time capability of localization, mapping and path planning of the unmanned system.

Furthermore, the system hub module, the trajectory tracking module, and the image frame module of the SLAM system will analyze and process the environment image, the environment sparse depth image, and the inertial information, and will finally output the corresponding pose information. The pose information is used for localization, mapping and path planning.

In this embodiment, the environment image, the environment sparse depth image, and the inertial information of the unmanned system are analyzed and processed through the system hub module, the trajectory tracking module and the image frame module of the preset SLAM system respectively, then the corresponding pose information can be acquired. The SLAM system of this embodiment includes a system hub module, a trajectory tracking module, and an image frame module, which will realize different sub-functions respectively. In this way, the calculation and analysis process of the pose information can be controlled separately, and the accuracy of the localization, mapping and routing of unmanned systems can be improved.

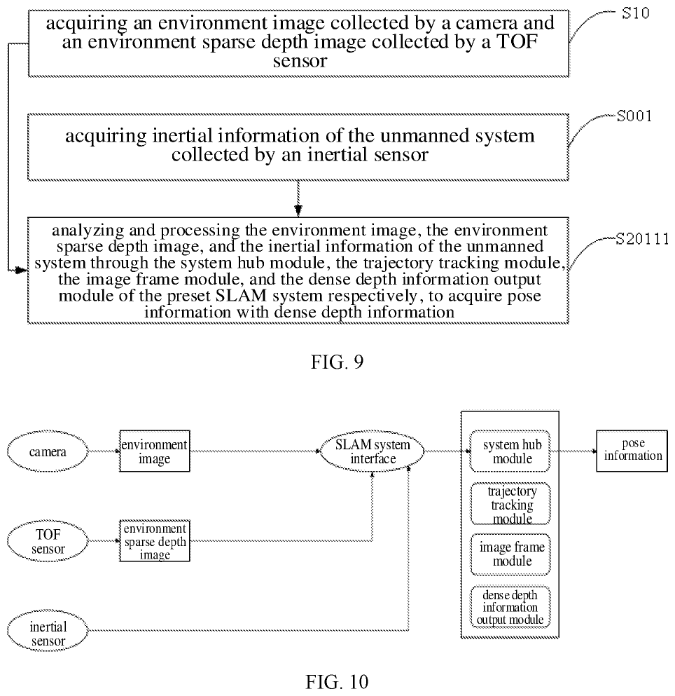

Further, as shown in FIG. 9, the fourth embodiment of the SLAM method based on sparse depth images of the present application provides a schematic flowchart. Based on the above embodiments shown in FIG. 7, the preset SLAM system further includes a dense depth information output module. Operation S2011, analyzing and processing the environment image, the environment sparse depth image, and the inertial information of the unmanned system through the system hub module, the trajectory tracking module, and the image frame module of the preset SLAM system respectively, to acquire the corresponding pose information includes:

operation S20111, analyzing and processing the environment image, the environment sparse depth image, and the inertial information of the unmanned system through the system hub module, the trajectory tracking module, the image frame module, and the dense depth information output module of the preset SLAM system respectively, to acquire pose information with dense depth information. The definition of “dense” is opposite to “sparse”, and the dense depth information can be a high-resolution depth image. It can be understood that, compared with sparse depth images, high-resolution depth images have more and denser depth points, which can be used to realize functions such as precise obstacle avoidance in unmanned systems.

As shown in FIG. 10, which is a fourth system architecture diagram related to the SLAM method based on the sparse depth image of the present application. The SLAM system in this embodiment includes a dense depth information output module. On the basis of receiving the environment sparse depth image, the SLAM system further outputs dense depth information through the dense depth information output module, and acquires pose information with dense depth information.

In this embodiment, by the above-mentioned solution, specifically, by analyzing and processing the environment image, the environment sparse depth image, and the inertial information of the unmanned system through the system hub module, the trajectory tracking module, the image frame module, and the dense depth information output module of the preset SLAM system respectively, the pose information with the dense depth information can be acquired. The conventional SLAM system did not have the output function of dense depth information. In this embodiment, a dense depth information output module is provided in the SLAM system, and the dense depth information output module is used to output dense depth information to meet the requirements during the control process of obstacle avoidance and path planning of the unmanned system, thereby improving the accuracy and robustness of localization, mapping and path planning of the unmanned system.

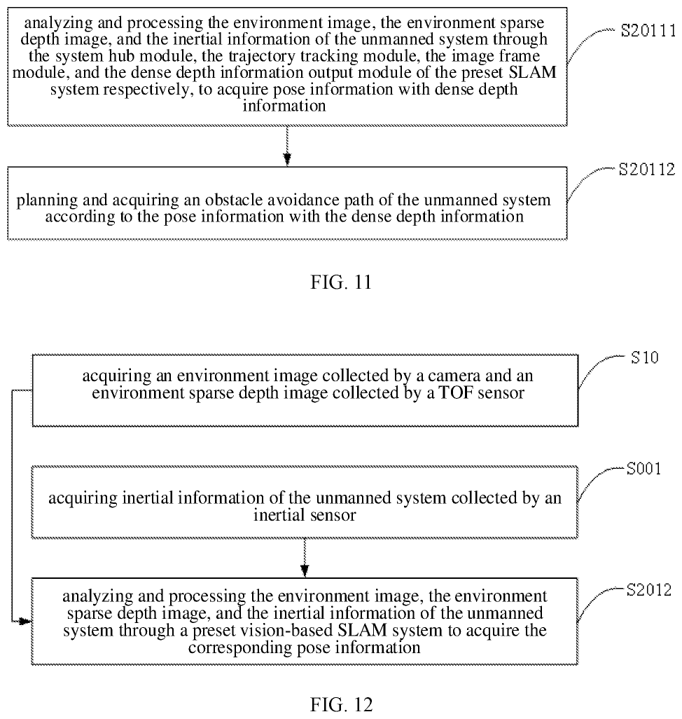

Further, as shown in FIG. 11, the fifth embodiment of the SLAM method based on sparse depth images of the present application provides a schematic flowchart. Based on the above embodiments shown in FIG. 9, operation S20111, analyzing and processing the environment image, the environment sparse depth image, and the inertial information of the unmanned system through the system hub module, the trajectory tracking module, the image frame module, and the dense depth information output module of the preset SLAM system respectively, to acquire pose information with dense depth information further includes:

operation S20112, planning and acquiring an obstacle avoidance path of the unmanned system according to the pose information with the dense depth information.

The depth information (included in the pose information) output by the dense depth information output module can be used for obstacle avoidance of the unmanned system. For example, the lawn mowing robot can avoid obstacles on the lawn based on the dense depth information outputted by the dense depth information output module, or can plan an obstacle avoidance path to avoid obstacles based on the dense depth information.

In this embodiment, by the above-mentioned solution, specifically, the obstacle avoidance path of the unmanned system can be planned according to the pose information with the dense depth information. This embodiment provides the application of pose information with dense depth information. The unmanned system can plan an accurate obstacle avoidance path according to the pose information with dense depth information, thereby effectively improving the accuracy and robustness of the obstacle avoidance function of the unmanned system.

Further, as shown in FIG. 12, the sixth embodiment of the SLAM method based on sparse depth images of the present application provides a schematic flowchart. Based on the above-mentioned embodiments shown in FIG. 5, operation S201, analyzing and processing the environment image and the environment sparse depth image through the preset SLAM system to acquire the corresponding pose information includes:

operation S2012, analyzing and processing the environment image, the environment sparse depth image, and the inertial information of the unmanned system through a preset vision-based SLAM system to acquire the corresponding pose information.

The SLAM system in this embodiment is a vision-based SLAM system, such as the ORB-SLAM system, the DROID-SLAM system, the New SLAM system, the Pro SLAM system, the LSD-SLAM system, the RGBD-SLAM system, and the like. The vision-based SLAM system mentioned above can be improved in combination with the environment sparse depth image in this embodiment, and then the environment image, the environment sparse depth image and the inertial information of the unmanned system can be analyzed and processed by the vision-based SLAM system to acquire the corresponding pose information.

In this embodiment, by the above solutions, specifically, by analyzing and processing the environment image, the environment sparse depth image, and the inertial information of the unmanned system through a preset vision-based SLAM system, the corresponding pose information can be acquired. In this embodiment, the environment sparse depth image is compatible with various vision-based SLAM systems, which effectively improves the accuracy of vision-based SLAM systems for localization, mapping and path planning of an unmanned system.

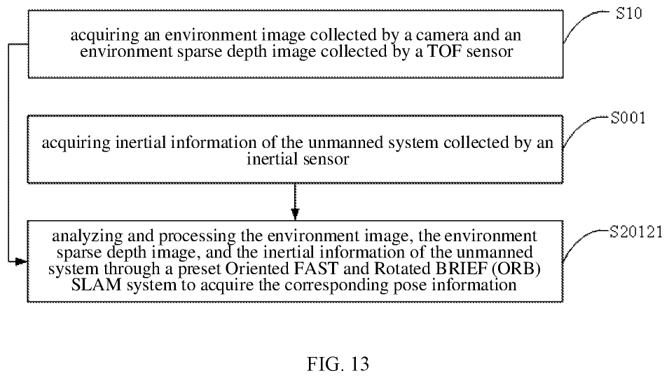

Further, as shown in FIG. 13, the seventh embodiment of the SLAM method based on sparse depth images of the present application provides a schematic flowchart. Based on the above-mentioned embodiments shown in FIG. 12, operation S2012, analyzing and processing the environment image, the environment sparse depth image, and the inertial information of the unmanned system through the preset vision-based SLAM system to acquire the corresponding pose information includes:

operation S20121, analyzing and processing the environment image, the environment sparse depth image, and the inertial information of the unmanned system through a preset Oriented FAST and Rotated BRIEF (ORB) SLAM system to acquire the corresponding pose information.

In this embodiment, the ORB-SLAM system is used to analyze and process the environment image, the environment sparse depth image, and the inertial information of the unmanned system to acquire corresponding pose information. The ORB-SLAM system has good versatility and can support multiple modes such as the monocular mode, the binocular mode, and the RGB-D mode. The loop detection algorithm ensures that the ORB-SLAM system can effectively restrain the cumulative error and adopt the same method to achieve relocation function, enabling the system to quickly relocate after failure. ORB-SLAM adopts 3 threads to complete the system, which realizes fast tracking and mapping, and can ensure the consistency of trajectory and mapping.

In this embodiment, by the above solutions, specifically, the preset ORB-SLAM system analyzes and processes the environment image, the environment sparse depth image, and the inertial information of the unmanned system to acquire corresponding pose information. This embodiment adopts the ORB-SLAM system, utilizes the advantages of the ORB-SLAM system to improve the mapping speed and the trajectory tracking speed, and ensure the consistency of trajectory and mapping.

In addition, an embodiment of the present application further provides an SLAM device based on a sparse depth image including:

an acquisition module configured to acquire an environment image collected by a camera and an environment sparse depth image collected by a TOF sensor; and

an analysis module configured to analyze and process the environment image and the environment sparse depth image through a preset SLAM system to acquire corresponding pose information, the pose information being used for localization, mapping and path planning of an unmanned system.

In this embodiment, the principle and process of implementing SLAM based on sparse depth images can refer to the above-mentioned embodiments, and details will not be repeated here.

In addition, an embodiment of the present application further provides a terminal equipment including a memory, a processor, and an SLAM program based on a sparse depth image stored in the memory and executable on the processor. When the SLAM program based on the sparse depth image is executed by the processor, the SLAM method based on the sparse depth image mentioned above is implemented.

When the SLAM program based on the sparse depth image is executed by the processor, all the technical solutions of the foregoing embodiments are adopted, so the SLAM program based on the sparse depth image at least has all the benefits brought by all the technical solutions of the foregoing embodiments, which will not be repeated here.

In addition, the embodiment of the present application further provides a non-transitory computer-readable storage medium. The SLAM program based on the sparse depth image is stored in the non-transitory computer-readable storage medium, and when the SLAM program based on the sparse depth image is executed by the processor, the SLAM method based on the sparse depth image mentioned above is implemented.

When the SLAM program based on the sparse depth image is executed by the processor, all the technical solutions of the foregoing embodiments are adopted, so the SLAM program based on the sparse depth image at least has all the benefits brought by all the technical solutions of the foregoing embodiments, which will not be repeated here.

Compared with the related art, embodiments of the present application provide an SLAM method and a device based on the sparse depth image, a terminal equipment and a medium. By acquiring an environment image collected by a camera and an environment sparse depth image collected by the TOF sensor, and analyzing and processing the environment image and the environment sparse depth image through a preset SLAM system, the corresponding pose information can be acquired. The pose information is used for localization, mapping and path planning of an unmanned system. Based on the technical solutions of the present application, the environment sparse depth image collected by the TOF sensor is used to provide the necessary depth information for the SLAM system, and combined with the environment image collected by the camera inputted to the SLAM system, the SLAM system can further analyze and acquire the corresponding pose information. In this way, by inputting the environment sparse depth image, the time for preparing depth information can be effectively reduced, and the operating speed of the SLAM system can be improved. Further, the performance of the SLAM system can be enhanced and energy consumption can be reduced.

It should be understood that, in the present application, the terms “including”, “includes” or any other variants are used for covering non-exclusive contents, so that a series of processes, methods, items or systems are all incorporated herein. Or the system not only includes those elements, but also includes other elements that are not clearly listed, or further includes the elements inherent in the process, the method, the item or the system. Without more restrictions, the elements limited by the description “include one . . . ” are not intended to exclude additional same elements in the process, the method, the item, or the system.

The serial numbers of the present application are only for description, and do not represent the advantages and disadvantages of the embodiments.

Those skilled in the art can understand that the above embodiments can be implemented by instructing the software and the general hardware platform, and can also be implemented by the hardware. In many cases, the former is better for implementation. The essence or the part contributing to the related art of the technical solutions of the present application can be embodied in the form of a software product. The computer software product can be stored in the storage medium (such as a read-only memory or a random access memory, a disk, and an optical disk) as mentioned above, and may include several instructions to cause a terminal equipment (which may be a mobile phone, a computer, a server, a controlled terminal, or a network equipment, and the like) to execute all or part of the operations of the methods described in the various embodiments of the present application.

The above-mentioned embodiments are only some embodiments of the present application, and are not intended to limit the scope of the present application. Any equivalent structure conversion or equivalent process conversion made with reference to the description and the accompanying drawings of the present application, directly or indirectly applied in other related technical fields, should all fall in the scope of the present application.

What is claimed is:

1. A simultaneous localization and mapping (SLAM) method based on a sparse depth image, comprising:
acquiring an environment image collected by a camera and an environment sparse depth image collected by a time of flight (TOF) sensor; and
analyzing and processing the environment image and the environment sparse depth image through a preset SLAM system to acquire corresponding pose information, wherein the pose information is used for localization, mapping and path planning of an unmanned system.

2. The SLAM method based on the sparse depth image of claim 1, wherein before the analyzing and processing the environment image and the environment sparse depth image through the preset SLAM system to acquire the corresponding pose information, the SLAM method further comprises:
acquiring inertial information of the unmanned system collected by an inertial sensor; and
wherein the analyzing and processing the environment image and the environment sparse depth image through the preset SLAM system to acquire the corresponding pose information comprises:
analyzing and processing the environment image, the environment sparse depth image, and the inertial information of the unmanned system through the preset SLAM system to acquire the corresponding pose information.

3. The SLAM method based on the sparse depth image of claim 2, wherein:
the preset SLAM system comprises a system hub module, a trajectory tracking module and an image frame module, and
the analyzing and processing the environment image, the environment sparse depth image, and the inertial information of the unmanned system through the preset SLAM system to acquire the corresponding pose information comprises:
analyzing and processing the environment image, the environment sparse depth image, and the inertial information of the unmanned system through the system hub module, the trajectory tracking module, and the image frame module of the preset SLAM system respectively, to acquire the corresponding pose information.

4. The SLAM method based on the sparse depth image of claim 3, wherein:
the preset SLAM system further comprises a dense depth information output module, and
the analyzing and processing the environment image, the environment sparse depth image, and the inertial information of the unmanned system through the system hub module, the trajectory tracking module, and the image frame module of the preset SLAM system respectively, to acquire the corresponding pose information comprises:
analyzing and processing the environment image, the environment sparse depth image, and the inertial information of the unmanned system through the system hub module, the trajectory tracking module, the image frame module, and the dense depth information output module of the preset SLAM system respectively, to acquire pose information with dense depth information.

5. The SLAM method based on the sparse depth image of claim 4, wherein after the analyzing and processing the environment image, the environment sparse depth image, and the inertial information of the unmanned system through the system hub module, the trajectory tracking module, the image frame module, and the dense depth information output module of the preset SLAM system respectively, to acquire the pose information with the dense depth information, the SLAM method further comprises:
planning and acquiring an obstacle avoidance path of the unmanned system according to the pose information with the dense depth information.

6. The SLAM method based on the sparse depth image of claim 2, wherein the analyzing and processing the environment image and the environment sparse depth image through the preset SLAM system to acquire the corresponding pose information comprises:
analyzing and processing the environment image, the environment sparse depth image, and the inertial information of the unmanned system through a preset vision-based SLAM system to acquire the corresponding pose information.

7. The SLAM method based on the sparse depth image of claim 6, wherein the analyzing and processing the environment image, the environment sparse depth image, and the inertial information of the unmanned system through the preset vision-based SLAM system to acquire the corresponding pose information comprises:
analyzing and processing the environment image, the environment sparse depth image, and the inertial information of the unmanned system through a preset Oriented FAST and Rotated BRIEF (ORB) SLAM system to acquire the corresponding pose information.

8. A simultaneous localization and mapping (SLAM) device based on a sparse depth image, comprising:
an acquisition module configured to acquire an environment image collected by a camera and an environment sparse depth image collected by a time of flight (TOF) sensor; and
an analysis module configured to analyze and process the environment image and the environment sparse depth image through a preset SLAM system to acquire corresponding pose information, wherein the pose information is used for localization, mapping and path planning of an unmanned system.

9. A terminal equipment, comprising:
a memory;
a processor; and
a simultaneous localization and mapping (SLAM) program based on a sparse depth image stored in the memory and executable on the processor, wherein when the SLAM program based on the sparse depth image is executed by the processor, the SLAM method based on the sparse depth image of claim 1 is implemented.

10. A non-transitory computer-readable storage medium, wherein a simultaneous localization and mapping (SLAM) program based on a sparse depth image is stored in the non-transitory computer-readable storage medium, when the SLAM program based on the sparse depth image is executed by a processor, the SLAM method based on the sparse depth image of claim 1 is implemented.
